(19) United States
(12) Patent Application Publication
(10) Pub. No.: US 2016/0372885 A1
(43) Pub. Date: Dec. 22, 2016

(54) LOSS ENGINEERING TO IMPROVE SYSTEM FUNCTIONALITY AND OUTPUT

(71) Applicant: Washington University, St. Louis, MO (US)

(72) Inventors: Lan Yang, St. Louis, MO (US); Sahin Kaya Ozdemir, St. Louis, MO (US); Bo Peng, St. Louis, MO (US)

(21) Appl. No.: 15/185,369

(22) Filed: Jun. 17, 2016

Related U.S. Application Data
(60) Provisional application No. 62/181,180, filed on Jun. 17, 2015.

(51) Int. Cl. H01S 3/30

(52) U.S. Cl. CPC H01S 3/302

(57) ABSTRACT

A system and method for engineering loss in a physical system by steering parameters of the physical system to the vicinity of an exceptional point is disclosed. In the vicinity of an exceptional point, localization of the fields helps to enhance any linear or nonlinear processes. As examples loss-induced transparency in the intracavity field intensities of coupled resonators, loss-induced suppression and enhancement of thermal nonlinearity in coupled resonators and loss-induced suppression and revival of Raman lasing in whispering-gallery-microcavities are demonstrated.

### CROSS REFERENCE

This application claims priority to and the benefit of U.S. Provisional Patent Application Ser. No. 62/181,180, entitled LOSS ENGINEERING TO IMPROVE SYSTEM FUNCTIONALITY AND OUTPUT, and filed on Jun. 17, 2015.

### STATEMENT FOR FEDERALLY SPONSORED RESEARCH

The Invention was made with government support under W911NF-12-1-0026 awarded by Army Research Office (ARO). The government has certain rights in the invention.

### BACKGROUND

Field

This technology relates generally to losses in physical systems and, more particularly, to managing loss within physical systems to improve functionality, efficiency and redistribution of energy.

Background Art

Loss can be a problem in any physical system, and in particular loss can be a problem in photonic system devices and laser system devices. Optical communication or particle detection systems are a few examples of physical photonic systems that experience problems with loss. Controlling and reversing the effects of loss in a physical system and providing sufficient gain to overcome losses can pose a challenge with any physical system, particularly in optical or photonic systems. This is especially true for laser based optical systems, for which the losses need to be overcome by a sufficient amount of gain to reach a lasing threshold.

Dissipation is ubiquitous in nature; and is essentially in all physical systems. A physical system with dissipation can be described by a non-Hermitian Hamiltonian featuring complex eigenvalues whose imaginary part may be associated with dissipation. Dissipation is the result of an inevitable and irreversible process that takes place in physical systems including chemical, electrical, optical, fluid flow, thermodynamic, photonic, plasmonic laser and other physical systems. A dissipative process is a process in which energy (internal, bulk flow kinetic, or system potential) is transformed from an initial form or state to a final form or state, where the capacity of the final form to do mechanical work or to perform the intended purpose is less than that of the initial form.

Other more efficient and innovative methods for engineering loss in physical systems as an alternative to simply increasing energy input or gain is needed.

### BRIEF SUMMARY

The invention is a technology comprising steering parameters of a physical system to the vicinity of an exceptional point (EP), which teaches a novel system and method for engineering loss into a system to improve system functionality.

Loss can be a problem in any physical system, and in particular photonic system devices and laser system devices. The present technology provides a new approach to reverse the effect of loss, and control for example optical responses, as well as responses of other physical systems. Controlling and reversing the effects of loss in a physical system and providing sufficient gain to overcome losses can pose a challenge with any physical system. This is especially true for laser based optical systems, for which the losses are typically overcome by providing a sufficient amount of gain to reach the lasing threshold. The present technology as disclosed and claimed can turn losses into gain by steering the parameters of a physical system, such as an optical system, or other type of physical system, to the vicinity of an exceptional point (EP), in which a non-Hermitian degeneracy is observed when the eigenvalues and the corresponding eigenstates of a physical system coalesce.

Within the domain of real parameters the exceptional points (EP) are the points where eigenvalues switch from real to complex values. EP is a point where both eigenvalues and eigenvectors merge. An exceptional point can appear in parameter dependent physical systems. They describe points in an at least two dimensional parameter space at which two (or more) eigenvalues and their corresponding eigenstates become identical (coalesce). EPs are involved in quantum phase transition and quantum chaos, and they produce dramatic effects for optical system multichannel scattering, specific time dependence and more. In nuclear physics they are associated with instabilities and continuum problems. EPs are spectral singularities and they also affect approximation schemes.

In physics, operators appear in quantum theory in the form of a Hamiltonian. Usually this Hamiltonian is Hermitian and has purely real eigenvalues, which are associated with a measurable energy. This is a sufficient description of a closed quantum system. A very effective description of open quantum systems interacting with an environment is often possible in terms of non-Hermitian Hamiltonians. These non-Hermitian operators possess in general complex eigenvalues. Due to their non-Hermiticity they may exhibit exceptional points. The imaginary part of an eigenvalue is interpreted as a decay rate of the corresponding state. The present technology as disclosed utilizes these characteristics and the effects around EP to manage the loss of a physical system.

By way of illustration, in a system of two coupled whispering gallery-mode silica microcavities, the EP transitions are manifested as the loss-induced suppression and revival of lasing. Below a critical value, adding loss to the system annihilates an existing Raman laser. Beyond this critical threshold, however, with the present technology as disclosed, the lasing recovers despite the increasing loss, in stark contrast to what one would expect from conventional laser theory. The results exemplify the counterintuitive features of non-Hermitian physics and present an innovative system and method for reversing the effect of loss. Contrary to expectations, introducing loss into a physical system, such as an optical system, can enhance physical processes rather than suppressing them.

In one implementation of the present technology as disclosed it can be used to manage loss within a microcavity resonator based optical system, where the total overall intracavity field intensity is increased to engineer an optical response of the system by engineering the loss of one of the subsystems (or parameters) of a system of coupled optical microcavities. The various implementations of the technology as disclosed provided loss induced recovery, as demonstrated by (1) loss-induced suppression and revival of Raman laser intracavity field intensity in silica resonators, and (2) nonlinear thermal response of the system. Various optical physical systems and their applications using the technology as disclosed will be described herein for illustration of industrial utility and applicability, however, the technology as disclosed can be utilized with other physical systems without departing from the scope of the technology as disclosed.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIGS. 1A thru 1E is an illustration of the effect of increasing loss on resonances;

FIG. 2A thru 2D is an illustration of the evolution of the transmission spectra and the eigenfrequencies as a function of loss and coupling strength;

FIGS. 3A thru 3D is an illustration of loss-induced enhancement of intracavity field intensities and thermal nonlinearity in the vicinity of an exceptional point;

FIGS. 4A and 4B is an illustration of loss-induced suppression and revival of Raman lasing in silica microcavities; and

FIGS. 5A and 5B are illustrations of non-Hermitian physical systems implementing the present technology as disclosed.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

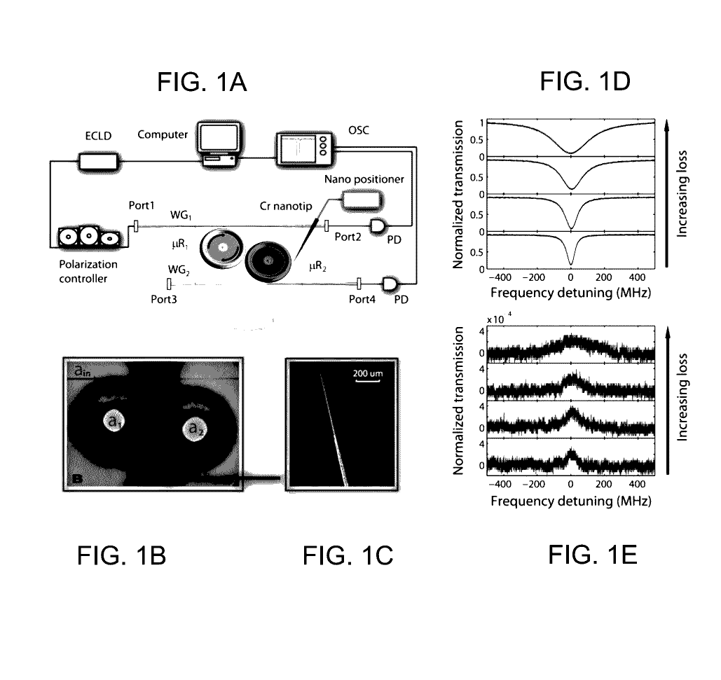

According to the embodiment(s) of the present invention, various views are illustrated in FIG. 1-5 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present technology includes steering parameters of a physical system to the vicinity of an exceptional point (EP), which teaches a novel system and method for engineering loss into a system to improve system functionality.

Dissipation is ubiquitous in nature; essentially all physical systems can thus be described by a non-Hermitian Hamiltonian featuring complex eigenvalues and non-orthogonal eigenstates. Dissipation is the result of an inevitable and irreversible process that takes place in physical systems including photonic, chemical, electrical, optical, thermal, fluid flow, thermodynamic and other physical systems. A dissipative process is a process in which energy (internal, bulk flow kinetic, or system potential) is transformed from some initial form to some final form, where the capacity of the final form to do mechanical work or to perform the intended purpose is less than that of the initial form. For example, heat transfer or optical systems are dissipative because it is a transfer of internal energy from one state to another state.

Following the second law of thermodynamics, entropy varies with temperature (reduces the capacity of the combination of the two bodies to do mechanical work), but never decreases in an isolated system. Energy is not lost, however, it can be transformed into a state that is no longer usable for the intended purpose. These processes produce entropy at a certain rate. Important examples of irreversible processes are: heat flow through a thermal resistance, fluid flow through a flow resistance, diffusion (mixing), chemical reactions, electrical current flow through an electrical resistance (Joule heating), and optical waveguide loss.

By way of illustration, thermodynamic dissipative processes are essentially irreversible. They can produce entropy at a finite rate. In a process in which the temperature is locally continuously defined, the local density of rate of entropy production times local temperature gives the local density of dissipated power. A particular occasion of occurrence of a dissipative process cannot be described by a single individual Hamiltonian formalism. A dissipative process requires a collection of admissible individual Hamiltonian descriptions, exactly which one describes the actual particular occurrence of the process of interest being unknown. This includes friction, and all similar forces that result in decoherence—that is, conversion of coherent or directed energy flow into an incoherent, indirected or more isotropic distribution of energy.

Although the technology as disclosed herein can be utilized to manage system loss for any physical system, the detailed description will primarily discuss the technology in the context of optical systems. However, use of the technology in optical systems is one of several applications.

When tuning the parameters of a physical system appropriately, its eigenvalues and the corresponding eigenstates may coalesce, giving rise to a non Hermitian degeneracy, also called an Exceptional Point (EP). The presence of a nearby EP usually has a dramatic effect on a system's properties, leading to nontrivial physics with unexpected results.

The effect on the operation of a physical system around an EP can be demonstrated by way of experimentation with mechanically-tunable resonators, where effects, such as “resonance trapping”, a mode exchange when encircling an EP, and the successful mapping of the characteristic parameter landscape around an EP, are observed. Experimentation also demonstrates how these characteristics can be employed to control the flow of light in optical devices with loss and gain. In particular, waveguides having parity-time symmetry have been managed with the present technology as disclosed, where loss and gain are carefully balanced, with effects like loss-induced transparency, unidirectional invisibility, and reflectionless scattering in a metamaterial being observed.

Experimentation using the technology as disclosed demonstrates that EPs give rise to many intriguing effects when they occur near the lasing regime in the case of laser technology. The lasing regime is a region of operation of a laser where the emissions are orders of magnitude greater. The lasing threshold is the lowest excitation level at which a laser's output is dominated by stimulated emission rather than by spontaneous emission. Below the threshold, a laser's output power rises slowly with increasing excitation. Whereas, above the threshold, the slope of power vs. excitation is orders of magnitude greater. The linewidth of the laser's emission also can become orders of magnitude smaller above the threshold than it is below. When operating in a region above the threshold, the laser is said to be lasing.

Examples of the intriguing effects that EPs include, enhancement of the laser linewidth, fast self-pulsations, coherent perfect absorption of light, and a pump-induced lasing suppression. Realizing such anomalous phenomena can be demonstrated by moving from waveguides to coupled resonators which can trap and amplify light resonantly beyond the lasing threshold. Such devices can be made available and are well known in the art area.

The technology as disclosed herein provides the realization of an unexpected result that is counterintuitive in light of traditional approaches to managing system losses. Introducing loss to a resonator system close to an EP lasing threshold operating condition produces a surprising effect that is contrary to the conventional textbook knowledge on laser operation and managing loss. This has been demonstrated by using a system that consists of two directly-coupled silica microtoroidal whispering-gallery-mode resonators (WGMRs) μR₁ and μR₂, each coupled to a different fiber-taper coupler WG1 and WG2 (See FIG. 1A).

An optical cavity, resonating cavity or optical resonator, is an arrangement of mirrors that form a standing wave cavity resonator for light waves. Optical micro cavities confine light at resonance frequencies for extended periods of time. Optical cavities are a major component of lasers that surround the gain medium and provide feedback of the laser light. They are also used in optical parametric oscillators and some interferometers. Light confined in the cavity reflect multiple times producing standing waves for certain resonance frequencies. The standing wave patterns produced are called modes; longitudinal modes differ only in frequency while transverse modes differ for different frequencies and have different intensity patterns across the cross section of the beam. Optical cavities are designed to have a large Q factor meaning a lower rate of energy loss. A beam will reflect a very large number of times with little attenuation. Therefore the frequency line width of the beam is very small compared to the frequency of the laser. However, even these efficient systems suffer with loss and the loss has to be effectively managed.

A more specific example included in the description herein are Whispering gallery waves, which can be produced in microscopic glass spheres or toruses, for example, with applications in lasing. The light waves are almost perfectly guided around by optical total internal reflection, leading to very high Q factors in excess of 10¹⁰. Optical modes in a whispering gallery resonator are however inherently lossy due to a mechanism similar to quantum tunneling. Strictly speaking, ideal total internal reflection does not take place at a curved boundary between two distinct media, and light inside a whispering gallery resonator cannot be perfectly trapped, even under theoretically ideal conditions. Such a loss channel has been known from research in the area of optical waveguide theory and is dubbed tunneling ray attenuation in the field of fiber optics. The Q factor is proportional to the decay time of the waves, which in turn is inversely proportional to both the surface scattering rate and the wave absorption in the medium making up the gallery.

The present technology as disclosed utilizes loss to control a physical system, in this example a whispering gallery mode microresonator, to control absorption loss, scattering loss or any other loss. The technology as disclosed utilizes loss to increase efficiency of a physical system and change the energy distribution within the system. The standing wave patterns or modes can be considered as subsystems within a cavity. The field of different modes can be redistributed more efficiently using the present technology. This is demonstrated by experimentation as disclosed herein.

Traditionally in order to overcome loss, the input gain is increased. When implementing the present technology, the resonance frequencies of the Whispering Gallery Mode Resonators (WGMRs) can be tuned to be the same (zero-detuning) via the thermo-optic effect, and achieve a controllable coupling strength K between the WGMRs in the 1550 nm band by adjusting the inter-resonator distance. The intrinsic quality factors of μR1 and μR2 were Qₒ₁=6.9×10⁶ and Qₒ₂=2.6×10⁷, respectively.

To observe the behavior of the coupled system in the vicinity of an EP the system can be steered parametrically via K and an additional loss γₜᵢₚ induced on μR₂ by a chromium (Cr)-coated silica-nanofiber γₜᵢₚ (FIGS. 1B and 1C), which features strong absorption in the 1550 nm band. The strength of tip γₜᵢₚ can be increased by enlarging the volume of the nanotip within the μR₂ mode field, resulting in a broadened linewidth of the resonance mode in μR₂ with no observable change in its resonance frequency. The nanotip thus affects only the imaginary part of the effective refractive index of μR₂ but not its real part (FIG. 1D).

A small fraction of the scattered light from the nanotip coupled back into μR₂ in the counter-propagating (backward) direction and leads to a resonance peak whose linewidth is broadened, but the resonance frequency remains the same as the loss is increased (FIG. 1E). The resonance peak in the backward direction is approximately 1/10⁴ of the input field, confirming that the linewidth-broadening and the decrease in the depth of the resonance in the forward direction are due to γₜᵢₚ via absorption and scattering to the environment but not due to back-scattering into the resonator.

In a first set of experiments to demonstrate the technology the WG₂ is moved away from μR₂ to eliminate the coupling between them. The evolution of the eigenfrequencies and the transmission spectra T_{1→2} from input Port 1 to output Port 2 can be observed while continuously adding more loss γₜᵢₚ to μR₂ while keeping K fixed. In this configuration, losses experienced by μR₁ and μR₂ were γ′₁=γ₁+γ_{c1} and γ′₂=γ₂+γₜᵢₚ, respectively, where γ_{c1} is the WG1-μR1 coupling loss, and γ₁ and γ₂ including material absorption, scattering, and radiation losses of μR₁ and μR₂.

The coupling between the WGMRs leads to the formation of two supermodes characterized by complex eigenfrequencies (ω₊=v′₁+V″₁ and ω₋=v′₂+iv″) given by ω_{±}=ωₒ−iχ±β, where χ=(γ₁′+γ₂″)/4 and Γ=(γ₁′−γ₂″)/4, β=\sqrt{K²−Γ²} and ω₀ is the complex resonance frequency of each of the solitary WGMRs.

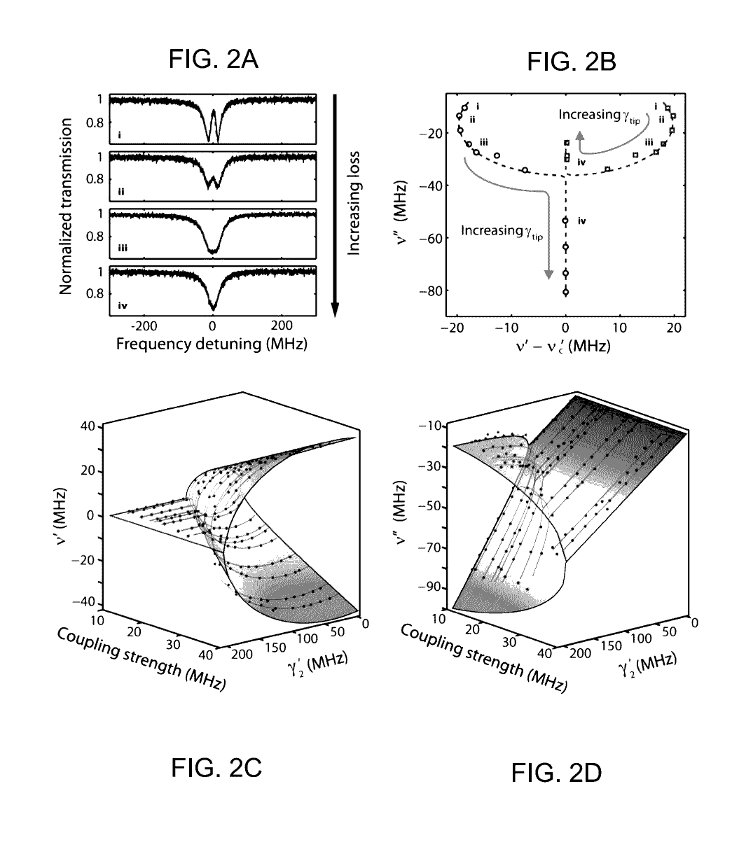

In the strong coupling regime, quantified by K>|Γ| (that is, real β), the supermodes have different resonance frequencies (that is, mode splitting of 2β) but the same linewidths quantified by χ. This is reflected as two spectrally-separated resonance modes in the measured transmission spectra T_{1→2} [FIG. 2A(i)] and in the corresponding eigenfrequencies [FIG. 2B(i)]. Since the system satisfies γ₁+γ_{c1}>γ₂, introducing the additional loss γₜᵢₚ to μR₂ increases the amount of splitting until γ₁+γ_{c1}=γ₂+γₜᵢₚ (that is, γ′₁=γ′₂) is satisfied [FIGS. 2A(ii) and 2B(ii)].

Increasing γₜᵢₚ beyond this point gradually brings the resonance frequencies of the supermodes closer to each other, and finally makes it difficult to resolve the split modes clearly [FIG. 2A(iii)] because the linewidths of the modes become larger than their splitting. This case of overlapping resonances requires an extraction of the complex resonance parameters by fitting the experimental data to a theoretical model in which the set of free parameters is limited due to the inherent symmetry of our setup.

At γₜᵢₚ=γₜᵢₚ^{EP}, where K=|Γ|, the supermodes coalesce at the EP. With a further increase γₜᵢₚ the system enters the weak-coupling regime, quantified by K<|Γ|, where β becomes imaginary, leading to two supermodes with the same resonance frequency but with different linewidths [FIGS. 2A(iv) and 2B(iv)].

The resulting resonance trajectories in the complex plane clearly display a reversal of eigenvalue evolution (FIG. 2B). The real parts of the two eigenfrequencies of the system first approached each other while keeping their imaginary parts equal until the EP. After passing the EP, their imaginary parts were repelled, resulting in an increasing imaginary part for one of the eigenfrequencies and a decreasing imaginary part for the other. As a result, one of the eigenfrequencies is shifted upwards in the complex plane (and the mode became less lossy) while the other is shifted downwards (and the mode became more lossy).

By repeating the experiments for different K and γₜᵢₚ the eigenfrequency surfaces ω_{±} (K, γ′₂) is obtained. Depicted are both their real and imaginary parts V′_{1,2} (K, γ′₂) and V″_{1,2} (K, γ′₂) in FIGS. 2C and 2D, respectively. The resulting exhibit a complex square-root-function topology with the special feature that, due to the identical resonance frequencies (O of the solitary WGMRs, a coalescence of the eigenfrequencies can be realized by varying either K or γₜᵢₚ alone, leading to a continuous thread of EPs along what may be called an exceptional line. As expected, the slope of this line is such that stronger K requires higher values of γₜᵢₚ, to reach the EP.

A second set of experiments is designed to elucidate and demonstrate the effect of the EP phase transition on the intracavity field intensities. The scheme illustrated in FIG. 1A is used with both WG₁ and WG₂, and introducing an additional coupling loss γ_{c2} to μR₂ (that is, γ′₂=γ₂+γₜᵢₚ+γ_{c2}). Two different cases are tested by choosing different mode pairs in the resonators. In the first case (Case 1), the mode chosen in μR₁ had higher loss than the mode in μR₂ (γ₁+γ_{c1}>γ₂+γ_{c2}). In the second case (Case 2), the mode chosen in μR2 had higher loss than the mode in μR1 (γ₁+γ_{c1}<γ₂+γ_{c2}). In both cases, γₜᵢₚ was introduced to μR₂.

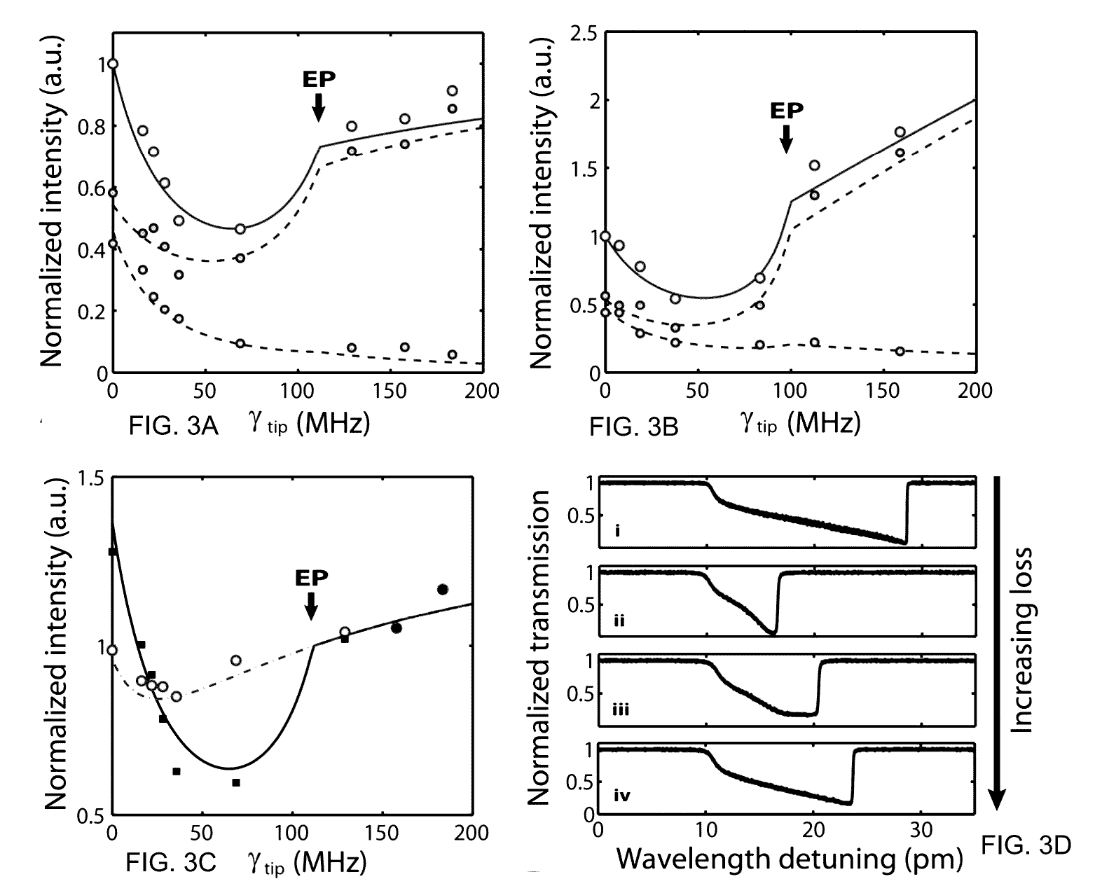

The system is adjusted so that two spectrally-separated supermodes are observed in the transmission spectra T_{1→2} and T_{1→4} as prominent resonance dips and peaks, respectively, at output ports 2 and 4. No resonance dip or peak is observed at port 3. Using experimentally-obtained T_{1→2} and T_{1→4} the intracavity fields and I₂ are estimated, and the total intensity I_{T}=I₁+I₂ as a function of γₜᵢₚ (FIG. 3A-C). Surprisingly, as γₜᵢₚ increases, the total intensity I_{T} first decreased and then started to increase despite increasing loss. This loss-induced recovery of the intensity is in contrast to the expectation that the intensity would decrease with increasing loss and is a direct manifestation of the EP phase transition.

The effect of increasing γₜᵢₚ on I₁ and I₂ at ω_{±} is depicted in FIGS. 3A and 3B for Cases 1&2, respectively. When γₜᵢₚ=0, the system is in the strong-coupling regime, and hence the light input at the μR₁ is freely exchanged between the resonators establishing evenly distributed supermodes. As a result, the intracavity field intensities are almost equal. As γₜᵢₚ is increased, I₁ and I₂ decreased continuously at different rates until I₁ and I₂ reached a minimum at γₜᵢₚ=γₜᵢₚ^{min}. The rate of decrease is higher for I₂ due to increasingly higher loss of μR₂. Beyond γₜᵢₚ^{min} until the EP is reached at γₜᵢₚ=γₜᵢₚ^{EP}, the system remained in the strong-coupling regime, but the supermode distributions are strongly affected by γₜᵢₚ, leading to an increase of I₁ and hence of I_{T} while no significant change is observed for I₂. Increasing γₜᵢₚ further pushed the system beyond the EP, thereby completing the transition from the strong-coupling to the weak-coupling regime during, which I₁ increased significantly and kept increasing whereas I₂ of μR₂ continued decreasing. This behavior is a manifestation of the progressive localization of one of the supermodes in the less lossy μR₁ and of the other supermode in the more lossy μR₂. It can be concluded that the non-monotonic evolution of I_{T} for increasing values of γₜᵢₚ is the result of a transition from a symmetric to an asymmetric distribution of the supermodes in the two resonators.

The initial difference in the loss contrast between the resonators is reflected in the amount of γₜᵢₚ required to bring the system to the EP. γₜᵢₚ^{EP} is higher for Case 1 than for Case 2 depending on the initial loss contrast, even a small amount of γₜᵢₚ may complete the transition from the strong to the weak-coupling regime. Increasing γₜᵢₚ in Case 2 increased I_{T} to a much higher value than that at γₜᵢₚ=0; in Case 1, on the other hand, I_{T} stayed below its initial value at γₜᵢₚ=0.

Finally, as seen in FIG. 3C, the intracavity field intensities at ω_{±} and ω₀ coincide when γₜᵢₚ≧γₜᵢₚ^{EP} (i.e., after the EP transition to the weak coupling regime). This is a direct consequence of the coalescence of eigenfrequencies ω_{±} at ω₀.

Whispering-gallery-mode micro-resonators combine high quality factors Q (long photon storage time; strong resonant power build-up) with micro-scale mode volumes V (tight spatial confinement; enhanced resonant field intensity) and are thus ideal tools in a variety of fields ranging from quantum electrodynamics and optomechanics to sensing. In particular, the ability of WGMRs to provide high intracavity field intensity and long interaction time significantly reduces the thresholds for nonlinear processes and lasing, and increases light-matter interaction thus leading to better sensors and detectors.

Therefore, the demonstrated loss-induced reduction and the recovery of the total intracavity field intensity impacts directly any linear or nonlinear process, including but not limited to the thermal nonlinear response and the lasing threshold of WGMRs. Thermal nonlinearity and the subsequent bistability in WGMRs are due to the temperature dependent resonance-frequency shifts caused by the material absorption of the intracavity field and the resultant heating. In silica WGMRs, this is pronounced as thermal broadening of the resonance line when the wavelength of the laser is scanned from shorter to longer wavelengths. (The laser wavelength is scanned in the same direction as the thermal shift due to the positive thermo-optic coefficient of silica.) This allows the laser to stay on resonance for a large range of detuning.

When the laser is scanned from longer to shorter wavelengths, the effect leads to a thermal narrowing of the resonance line. In a demonstration system under experimentation, thermal nonlinearity is clearly observed in T_{1→2} as a shark-fin feature (FIG. 3D). With a high input power of 600 μW, thermal broadening kicked in and made it impossible to resolve the individual supermodes. When the loss is introduced to μR₂ and gradually increased, thermal nonlinearity and the associated linewidth broadening decreased at first and then gradually recovered (FIG. 3D). This aligns well with the evolution of the total intracavity field as a function of loss.

The effect of the loss-induced recovery of the intracavity field intensity on the Raman lasing in silica microtoroids can be tested. A Raman laser is a specific type of laser in which the fundamental light-amplification mechanism is stimulated Raman scattering. In contrast, most “conventional” lasers (such as the ruby laser) rely on stimulated electronic transitions to amplify light. Raman scattering is the inelastic scattering of a photon and is a nonlinear process in which the frequency of the incident photons is red-shifted or blue-shifted (Stokes or anti Stokes photons) by an amount equivalent to the frequency of the optical phonons present in the material system. When photons are scattered from an atom or molecule, most photons are elastically scattered (Rayleigh scattering), such that the scattered photons have the same energy (frequency and wavelength) as the incident photons.

A small fraction of the scattered photons (approximately 1 in 10 million) are scattered by an excitation, with the scattered photons having a frequency different from, and usually lower than, that of the incident photons. The Raman interaction leads to two possible outcomes: the material absorbs energy and the emitted photon has a lower energy than the absorbed photon (Stokes-Raman Scattering); or the material loses energy and the emitted photon has a higher energy than the absorbed photon (Anti-Stokes).

Raman gain is the optical amplification arising from stimulated Raman scattering. It can occur in transparent solid media like optical fibers, liquids and gases. Its magnitude depends on the optical frequency offset between the light pump and signal wave, and to some smaller extent on the pump wavelength, and on material properties.

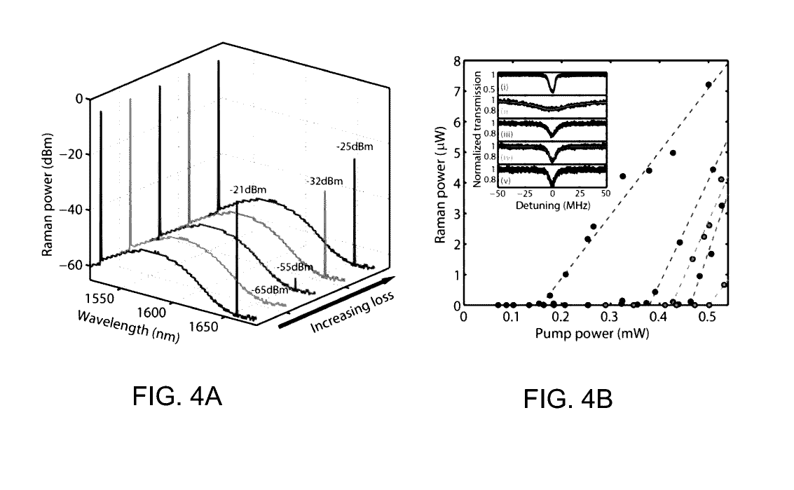

Raman gain g_{R} in silica takes place in a frequency band 5-40 THz red-shifted from the pump laser with the peak gain occurring at 13.9 THz and 14.3 THz. If the provided Raman gain becomes larger than the losses in a WGMR, Raman lasing sets in. The threshold for Raman lasing scales as P_{Raman-threshold}∝V/g_{R}Q², implying the significance of the pump intracavity field intensity and Q of the modes in the process. With a pump laser in the 1550 nm wavelength band, Raman lasing takes place in the 1650 nm band in silica WGMR. FIG. 4 depicts the spectrum and the efficiency of Raman lasing in the system. The lasing threshold for the solitary resonator is about 150 μW (FIG. 4B first curve from left to right).

Keeping the pump power fixed, the second resonator is introduced, which has a much larger loss than the first one. This effectively increased the total loss of the system and annihilated the laser (FIG. 4A, fifth curve from left to right). Introducing additional loss γₜᵢₚ to the second resonator helps to recover the Raman lasing, whose intensity increased with increasing loss (FIG. 4A). The lasing threshold of each of the cases depicted can be confirmed as illustrated in FIG. 4A and it is observed that as γₜᵢₚ is increased, the threshold power increased at first but then decreased (FIG. 4B).

These results are contrary to what one would expect in conventional systems, where the higher the loss, the higher the lasing threshold. The technology as disclosed for engineering loss provides an unexpected result. Surprisingly, in the vicinity of an EP, less loss is detrimental and annihilates the process of interest. However, as an unexpected result more loss helps to recover the process. These counterintuitive and unexpected results can be explained by the fact that the supermodes of the coupled system readjust themselves as loss is gradually increased. When the loss exceeds a critical amount, the supermodes are mostly located in the system with less loss and thus the total field can build up more strongly. As the results clearly demonstrate, this behavior also affects the nonlinear processes, such as thermal broadening and Raman lasing that rely on intracavity field intensity.

One implementation of the technology as disclosed demonstrates the influence of an EP and the corresponding phase transition on the properties of coupled WGM microresonators by steering the system via coupling strength and additional loss to the vicinity of an EP. One implementation of the technology as disclosed, provides for a loss-induced suppression and revival of thermal nonlinearity and Raman lasing, which results from the evolution of complex eigenvalues in the vicinity of an EP. The technology as disclosed and the specific optical implementation of the technology provides a comprehensive platform for additional applications for leveraging of EPs and opens up new avenues of research on non-Hermitian physical systems and their behavior. The unexpected result also provides schemes and techniques for controlling and reversing the effects of loss in various physical systems, such as in photonic crystal cavities, plasmonic structures, and metamaterials.

Referring to FIGS. 1A-1D, an illustration is provided for demonstrating one implementation of the technology illustrating the effect of increasing loss on the resonances. The demonstration configuration includes two directly coupled silica microtoroidal whispering gallery mode resonators (WGMRs) μR₁ and μR₂ with each coupled to a different fiber taper coupler WG₁ and WG₂. The demonstration configuration can also have a photodetector (PD), an oscilloscope OSC and an external cavity laser diode ECLD. Optical microscope images (top view) of coupled micro-resonators μR₁ and μR₂ are provided, together with the fiber taper coupler WG₁ and the Cr nanotip. aᵢₙ: input field at WG₁. a₁: intracavity field of μR₁. a₂: intracavity field of μR₂. FIG. 1C provides a scanning electron microscope (SEM) image of the Cr nanotip. FIGS. 1D and 1E provide transmission spectra in the forward (D) and backward (E) directions showing that additional loss broadened the resonance linewidth but did not affect its frequency. Also, backscattering due to the nanotip is very weak (E).

Referring to FIGS. 2A-2D, an evolution of the transmission spectra and the eigenfrequencies as a function of loss γₜᵢₚ and coupling strength K is provided. FIG. 2A illustrates the transmission spectra T_{1→2} showing the effect of loss on the resonances of supermodes. The two curves denote the experimental data and the best fit using a theoretical model, respectively. FIG. 2B illustrates the evolution of the eigenfrequencies of the supermode in the complex plane as γₜᵢₚ is increased. V′ and V″ are the real and imaginary parts of the eigenfrequencies. V′_{c} is the real part of the eigenfrequencies of uncoupled (solitary) microtoroids. Open circles and squares are the eigenfrequencies estimated from the measured T_{1→2} using the theoretical model. Dashed lines denote the best theoretical fit to the experimental data. FIGS. 2C and 2D illustrate the Eigenfrequency surfaces in the (K, γ′₂) parameter space.

Referring to FIGS. 3A-3D, loss-induced enhancement of intracavity field intensities and thermal nonlinearity in the vicinity of an exceptional point is illustrated. FIGS. 3A and 3B illustrate intracavity field intensities of the resonators at ω_{±} (from top to bottom—total I_{T}; I₁ of μR₁ and I₂ of μR₂). For FIG. 3A, Case 1, the initial loss of μR₁ is higher than that of μR₂, and for FIG. 3B, Case 2, the initial loss of μR₂ is higher than that of μR₁. Normalization is performed with respect to the total intensity at γₜᵢₚ=0 at EP: Exceptional point. FIG. 3C illustrates total intracavity field intensities I_{T} at eigenfrequencies ω_{±} (top) and ω₀ (bottom) for Case 1. Intensities coincide in the weak-coupling regime because it is at the EP and after EP in the weak-coupling regime whereby ω_{±} coalesces at ω₀. Normalization is performed with respect to the intensity at the exceptional point. FIG. 3D illustrates the effect of loss on nonlinear thermal response (thermal broadening) of the coupled system. Increasing loss first reduces the nonlinear response and then helps to recover it. Circular data points are calculated from the experimentally-obtained transmissions T_{1→2} and T_{1→4}. Curves are from the theoretical model. γₜᵢₚ is introduced to μR₂, which had more initial loss than μR₁ when γₜᵢₚ=0. Circles in FIGS. 3A, 3B and 3C and squares in FIG. 3C are experimentally-obtained data whereas the lines are from the theoretical model.

FIGS. 4A-4B loss-induced suppression and revival of Raman lasing in silica microcavities is illustrated. FIG. 4A illustrates a Raman lasing spectrum of coupled silica microtoroid resonators as a function of increasing loss. Additional loss initially annihilates the existing Raman laser but then the laser recovers as the loss is increased. FIG. 4B illustrates Raman power output versus incident pump power. As the loss is increased, the lasing threshold is initially increased and then decreased. The inset shows the normalized transmission spectra T_{1→2} in the pump band obtained at very weak powers for different amounts of additional loss. Loss increases from top to bottom. The curves of FIG. 4A and FIG. 4B and the inset legend of FIG. 4B coincide and are obtained at the same value of additionally introduced loss.

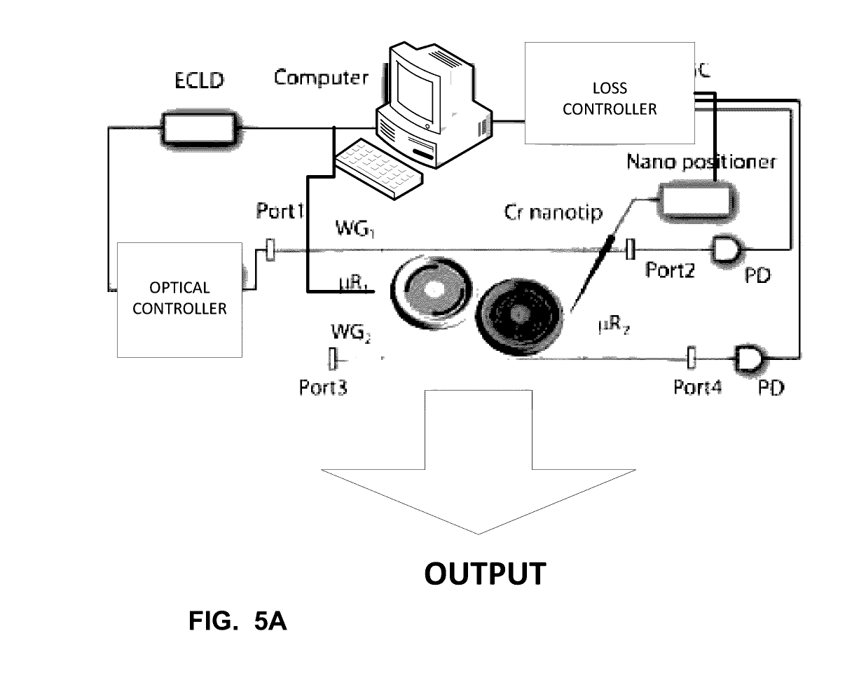

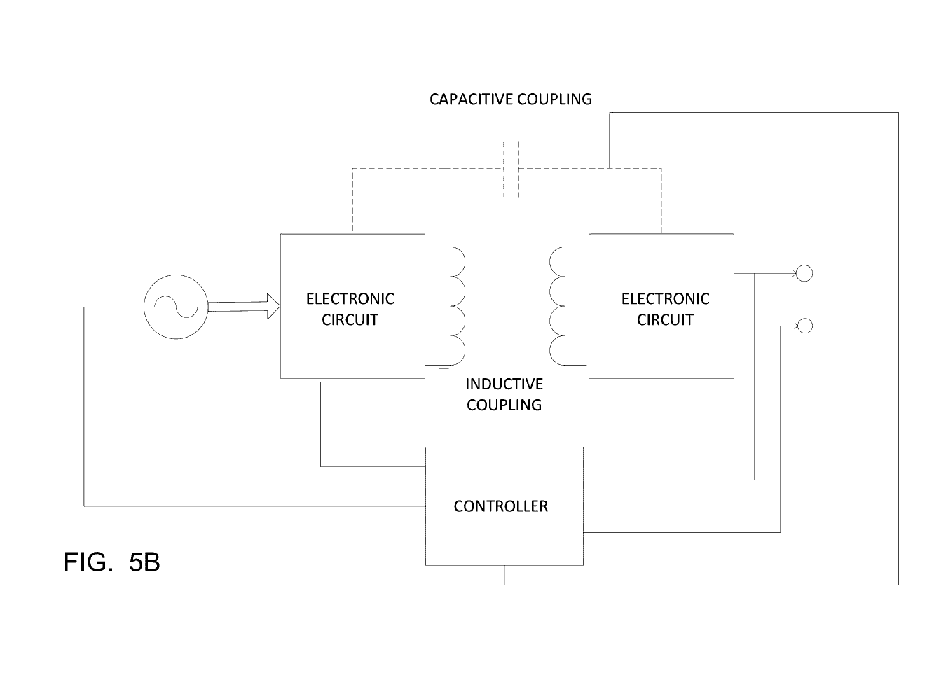

Referring to FIGS. 5A and 5B, two specific implementations of the technology as disclosed is implemented. In FIG. 5A, a microresonator based optical system is illustrated utilizing coupled Whispering Gallery microresonators WG₁ and WG₂ having modes fields μR₁ and μR₂. The technology as disclosed can be implemented utilizing different system configurations. For example, the output from the resonators can be monitored by photo diode sensing devices and the sensed output can be electronically transmitted to a loss controller. The loss controller can engineer loss in various ways including controlling a nano positioner to mechanically control one of the microresonator's positions to vary the coupling strength as described herein. The coupling strength parameter K can be tuned utilizing nano positioner. Alternatively, the loss controller can increase the loss of a selected mode field μR₁ or μR₂ to redistribute energy as desired to improve the output. Yet another implementation is to provide inputs to an optical controller using spectroscopy techniques to induce loss in particular mode fields about the EP. Various frequency parameters can be tuned to induce the desired loss.

In FIG. 5B, two electronic circuits are illustrated as being coupled together inductively or in the alternative capacitively. A controller can be utilized to tune (change) the inductance or the capacitance in order to vary the inductive or capacitive coupling strength parameter. The controller can also control a variable resistor to induce loss in certain modes fields of the electronic signal. The controller can also monitor the output to determine if the desired gain or loss is obtained.

The various implementations and examples shown above illustrate a method and system for engineering loss to improve the function of a physical system. A user of the present method and system may choose any of the above implementations, or an equivalent thereof, depending upon the desired application. In this regard, it is recognized that various forms of the subject method and system could be utilized without departing from the scope of the present implementation.

The disclosure is not limited to silica WGM resonators. It is valid for resonators of any type or material. For example with silicon resonators, Raman lasing from silicon is also OK. WGM resonator is one implementation described, but the concept is valid for waveguides, fiber networks etc. The examples provided is only for two resonators coupled two each other. In principle there is no limit on the number of subsystems in the non-Hermitian system. It can be a network of resonators or waveguides in different geometries or topologies. For example resonators as a linear chain, or resonators arranged in triangles or rectangular, and lattices. The non-Hermitian system can be a single system but then one can find two modes in this system such that the coupling and loss contrast between these modes can be tuned to bring the system to an EP.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. For example a module can be used to steer the parameters of a physical system toward an EP. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

As described herein, a machine can operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. For example a computing device can be used to generate an input to steer parameters of a system toward an EP or to introduce loss into a physical system to improve the systems functionality. Further, while only a single machine is illustrated, the term “machine” shall also be taken to include any collection of machines that individually or jointly execute a set (or multiple sets) of instructions to perform any one or more of the methodologies discussed herein.

A computer system can include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)) for displaying parameters relating to the performance of the physical system. The computer system can also include an alphanumeric input device (e.g., a keyboard), a cursor control device (e.g., a mouse), a drive unit, a signal generation device (e.g., a speaker) and a network interface device. The controller functions of the systems as illustrated in FIGS. 5A and 5B can be implemented utilizing a modified computing device with the appropriate software modules.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

Other aspects, objects and advantages of the present invention can be obtained from a study of the drawings, the disclosure and the appended claims.

What is claimed is:

1. A method for controlling the effects of loss in a non-Hermitian physical system comprising:
tuning at least one parameter of a non-Hermitian physical system to move the system toward an exceptional point; and
maintaining the at least one parameter fixed, while introducing additional loss into at least one mode or subsystem of the non-Hermitian physical system until the desired energy distribution is achieved.

2. The method as recited in claim 1, further comprising:
monitoring at least one mode or subsystem of the non-Hermitian physical system for loss; and
controlling the introduction of the additional loss to at least one mode or subsystem.

3. The method as recited in claim 2, where the at least one parameter includes a coupling strength.

4. The method as recited in claim 2, where the non-Hermitian physical system is a whispering-gallery-mode (WGM) coupled microcavity based laser optical system.

5. The method as recited in claim 4, where the WGM coupled microcavity based laser optical system includes coupled WGM microresonators configured with a nano-positioner controlled to adjust the coupling strength by varying an inter-resonator distance to thereby steer the microcavity based laser optical system toward the exceptional point, and where at least one of the WGM microresonators includes a nanofiber configured to induce loss.

6. The method as recited in claim 4, where the desired energy distribution achieves a lasing threshold.

7. The method as recited in claim 6, where the laser optical system is a Raman laser optical system.

8. The method as recited in claim 2, where the non-Hermitian physical system includes coupled electronic circuits coupled by one or more of an inductive and capacitive coupling.

9. The method as recited in claim 8, where the coupled electronic circuits includes a controller configured to vary one or more of the inductive and capacitive couplings to thereby steer the coupled electronic circuits toward the exceptional point and where at least one of the coupled electronic circuits is configured to control a variable resistance to induce loss in certain mode fields.

10. A system for controlling the effects of loss in a non-Hermitian physical system comprising:
a non-Hermitian physical system having at least one parameter being tuned to move the system toward operating about an exceptional point; and
said at least one parameter being fixed once the system is moved toward the exceptional point while at least one mode or subsystem of the non-Hermitian physical system has additional loss introduced.

11. The system as recited in claim 10, further comprising:
a sensor for monitoring at least one mode of the non-Hermitian physical system for loss; and
a controller for controlling the introduction of the additional loss.

12. The system as recited in claim 11, where the at least one parameter includes a coupling strength.

13. The system as recited in claim 11, where the non-Hermitian physical system is a whispering-gallery-mode (WGM) coupled microcavity based laser optical system.

14. The system as recited in claim 13, where the WGM coupled microcavity based laser optical system includes coupled WGM microresonators configured with a nano-positioner controlled to adjust the coupling strength by varying an inter-resonator distance to thereby steer the microcavity based laser optical system toward the exceptional point, and where at least one of the WGM microresonators includes a nanofiber configured to induce loss.

15. The system as recited in claim 14, where a desired energy distribution achieves a lasing threshold.

16. The system as recited in claim 15, where the laser optical system is a Raman laser optical system.

17. The system as recited in claim 12, where the non-Hermitian physical system includes coupled electronic circuits coupled by one or more of an inductive and capacitive coupling.

18. The system as recited in claim 17, where the coupled electronic circuits includes a controller configured to vary one or more of the inductive and capacitive couplings to thereby steer the coupled electronic circuits toward the exceptional point and where at least one of the coupled electronic circuits is configured to control a variable resistance to induce loss in certain mode fields.
